(19) United States
(12) Patent Application Publication
(10) Pub. No.: US 2003/0235528 A1
(43) Pub. Date: Dec. 25, 2003

(54) Spraying-combustion method for producting positive electrode material of Li-ion secondary battery

(75) Inventors: She-Huang Wu, Taipei (TW); Yung-Jen Lin, Taipei (TW); Mu-Rong Yang, Taipei (TW); Wen-Jen Liu, Taipei (TW); Yi-Shiuan Chen, Taipei (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei (TW)

(21) Appl. No.: 10/458,252

(22) Filed: Jun. 11, 2003

(30) Foreign Application Priority Data
Jun. 25, 2002 (CN) 91113886

(51) Int. Cl. C01G 45/12; C01F 7/04

(52) U.S. Cl. 423/599; 423/600; 426/596; 423/594.2; 423/594.4; 423/594.6

(57) ABSTRACT

A method for producing a positive electrode material of Li-ion secondary batteries is disclosed. The positive electrode material of the following formula (I),

Li₁₊ₓMn_{2-y}M_{y}O₄ (I)

wherein M is Al, Cr, Fe, Co, or Ni; 0≦x≦0.4, and 0≦y≦0.2. First, salts of Li, Mn and M are mixed with an organic acid to form an initial solution, wherein the mole ratio of Li, Mn and M ions in their respective salts is (1+x): (2−y): y. Next, the initial solution is injected into a spraying chamber of a combustor to generate powders. By adjusting flow rates of the initial solution, the output port of the spraying chamber is maintained at 150° C.-200° C. Finally, the final product can be obtained by heating the powders.

### BACKGROUND OF THE INVENTION

1. Field of the Invention

The present invention relates a spraying-combustion method for producing a positive electrode material of a Li-ion secondary battery, which is particularly suitable for being applied to mobile phones, portable computers, portable music players and other electrical devices in which the secondary batteries serve as power supplies.

2. Related Prior Art

Composites of lithium oxide, for example, Li/Co oxides, Li/Mn oxides and Li/Ni oxides, are widely used as the positive electrodes of secondary batteries, wherein the Li/Co oxides are most popular. Recently, Li/Mn oxide spinel is considered to replace the Li/Co oxide due to its advantages of low cost, safety and environment friendliness. In order to produce the Li/Mn oxide with better electrochemical properties and crystal structure, many processes are developed.

Solid-state reaction is one of the typical methods for producing the Li/Mn oxides. However, undesired phase, irregular particle shape, large and wide-distributied particle size, structure instability and long-time heat-treatment are adverse to this method. The wet chemical methods including sol-gel method, co-precipitating method and Pechini process may solve some aforementioned problems by heat-treatment at low temperature and with finer precursor powders. However, complicated synthesis and calcining procedures are required for these wet methods. Furthermore, undesired phases and irregularly-shaped particles still exist.

Spraying-drying method is widely used for producing fine ceramic powders in micrometer size. Unfortunately, the hollow structure thereof is not suitable for the secondary batteries.

Therefore, it is desirable to provide an improved method to mitigate and/or obviate the aforementioned problems.

### SUMMARY OF THE INVENTION

The object of the present invention is to provide a spraying-combustion method for producing a positive electrode material of an Li-ion secondary battery, which is carried out easily and quickly to obtain finer powders of Li/Mn oxides.

In order to achieved the above objects, the Li/Mn oxide of the following formula (I) is produced,

Li₁₊ₓMn_{2-y}M_{y}O₄ (I)

wherein M is Al, Cr, Fe, Co, or Ni; 0≦x≦0.4, and 0≦y≦0.2. First, salts of Li, Mn and M are mixed with an organic acid to form an initial solution. The mole ratio of Li, Mn and M ions in their respective salts is (1+x):(2−y):y. The initial solution is injected into a spraying chamber of a combustor to generate powders by adjusting the flow rates of the initial solution and maintaining the temperature of an output port of the spraying chamber at 150° C. -200° C. Finally, the powders are heated.

The aforementioned salts of Li, Mn and M are not restricted and can be nitrate, chloride, hydroxide, carbonate, or acetate. The organic acid can be acetic acid, propionic acid, butyric acid or citric acid. The mole ratio of the organic acid to Li ion in the Li salt is usually between 1:1 and 5:1, and preferably between 1:1 and 3:1, which facilitates crystallization of the positive electrode material. The powders are usually heated at 600° C. -900° C. for 1-8 hours.

Other objects, advantages, and novel features of the invention will become more apparent from the following detailed description when taken in conjunction with the accompanying drawings.

### BRIEF DESCRIPTION OF THE DRAWINGS

FIG. 1 shows a schematic diagram of the spraying combustor in accordance with the present invention;

FIG. 2 shows XRD analysis of the as-sprayed LiMn₂O₄ synthesized in accordance with the present invention;

FIG. 3 shows XRD analysis of LiMn₂O₄ with post heat-treatment at 800° C. for 4 hours;

FIG. 4 shows XRD analysis of LiMn₂O₄ with post heat-treatment at 800° C. for 8 hours; and

FIG. 5 shows charge capacities of various LiMn₂O₄ batteries with LiMn₂O₄ powders made through solid-state reaction, Pechini process, coprecipitating method and the method of the present invention, respectively.

### DETAILED DESCRIPTION OF THE PREFERRED EMBODIMENTS

The present invention provides a spraying-combustion method for producing a positive electrode material of the following formula (I),

Li₁₊ₓMn_{2-y}M_{y}O₄ (I)

wherein Li is lithium; Mn is manganese; M is aluminum (Al), chromium (Cr), iron (Fe), cobalt (Co) or nickel (Ni); 0≦x≦0.4, and 0≦y≦0.2. This material is adapted to an Li-ion secondary battery. In the spraying-combustion method, salts of Li, Mn and M are first mixed with an organic acid to form an initial solution, wherein the mole ratio of Li, Mn and M ions in their respective salts is (1+x):(2−y):y. The organic acid can be acetic acid, propionic acid, butyric acid or citric acid. The mole ratio of the organic acid to Li ion in the Li salt is usually between 1:1 and 5:1, and preferably between 1:1 and 3:1, which facilitates crystallization of the positive electrode material. The initial solution is injected into a spraying chamber of a combustor to generate powders by adjusting flow rates of the initial solution and maintaining the temperature of an output port of the spraying chamber at 150° C.-200° C. Finally, the powders are heated at 600° C.-900° C. for 1-8 hours.

In order to evaluate the performances of the prepared powder, the materials made by the method of the present invention and traditional methods are respectively coated on aluminum foils as positive electrodes. Lithium foils serve as the negative electrodes. An electrolyte of LiPF₆ (1M) is prepared with ethylene carbonate and diethylene carbonate in a volume ratio of 1:1.

Materials and equipment used in the present invention, for example, the spraying chamber, the apparatus for heating treatment, the metallic salts and the organic acid are well known by people skilled in this art. The following Example and Comparative Examples will be helpful to further understand the present invention.

### EXAMPLE

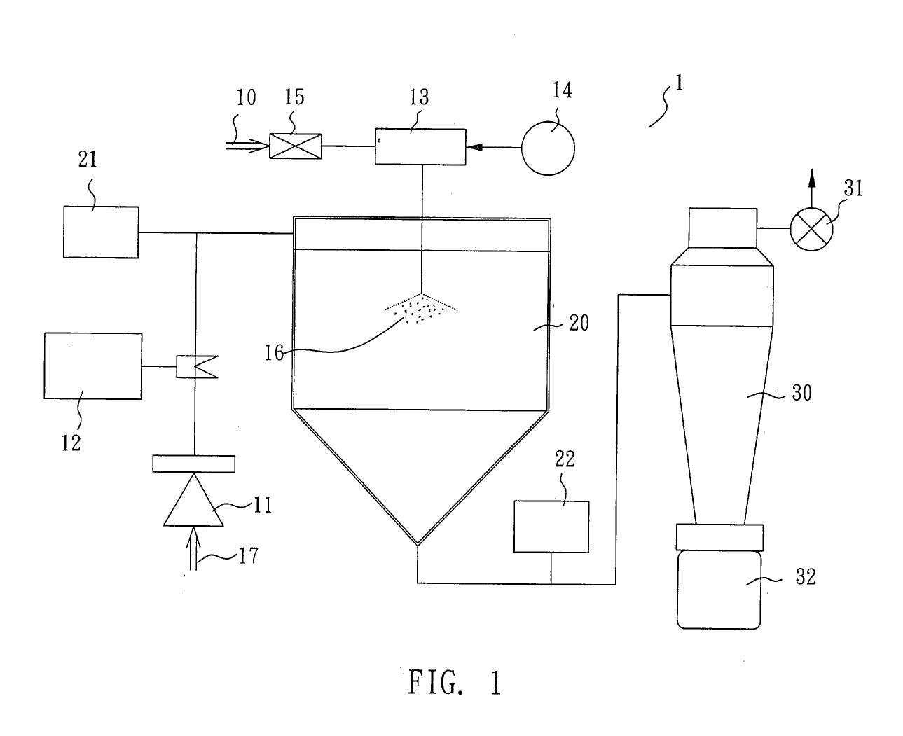

FIG. 1 shows the spraying combustor 1 used in the present invention. First, a feed 10 is prepared by dissolving lithium nitrate, manganese nitrate and citric acid in water, wherein the concentration of Li ion, Mn ion and citric acid are, respectively, 0.10M, 0.20M and 0.167M. An air flow 17 is filtered through an air filter 11 and heated by a heating device 12, whereby the inlet thermometer 21 of the spraying chamber 20 is 400° C. The feed 10 is then loaded in an atomizer 13 and then injected into the spraying chamber 20 to form droplets 16. The pressure in the atomizer 13 is controlled by the manometer 14 and the flow rate of the feed 10 is controlled by a flow meter 15, whereby the outlet thermometer 22 of the spraying chamber 20 can be over 150° C. Because of a long retention time of the droplets 16 in the spraying chamber 20, the hollow powders are self-ignited and decomposed into fine solid powders. Such solid structure may improve charge capacities of the battery. The powders are then separated from airflow by a cyclone 30 and are finally collected in a container 32 without additional calcining procedure. Gas in the cyclone 30 is discharged from exhaust equipment 31.

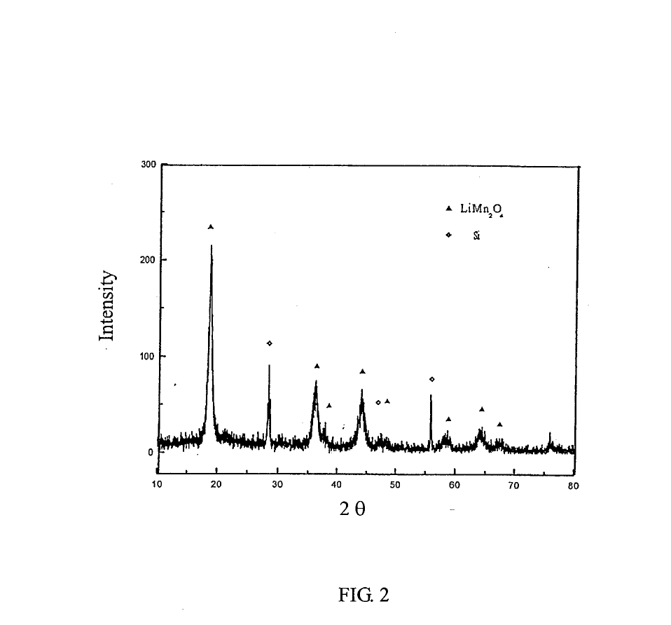

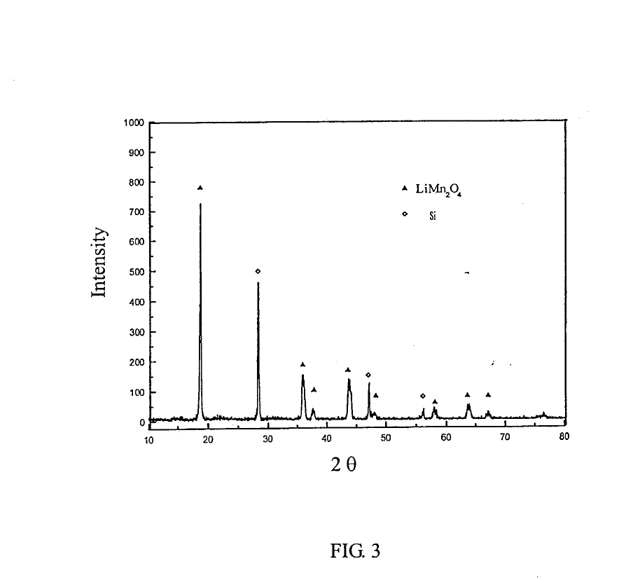

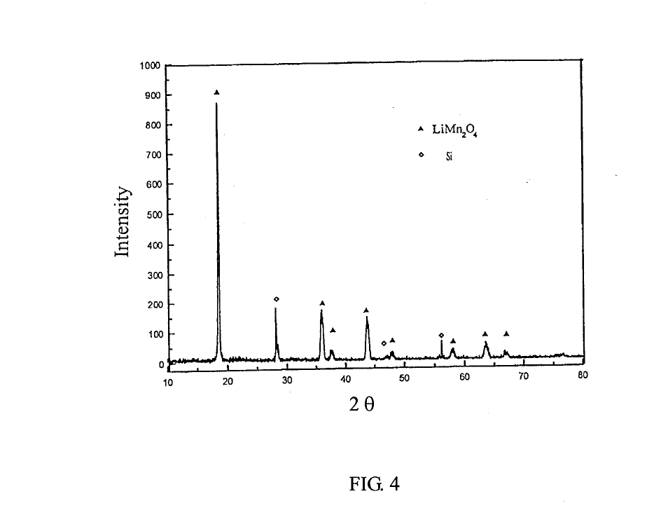

The collected powders are then heated in a furnace at a rate of 5° C./min for 4 hours and maintained at 800° C. for 8 hours. The product is then cooled down to room temperature at a rate of 1° C./min. The cooled Li/Mn oxides are analyzed with CuKα x-ray diffraction to identify the crystal structures thereof, as shown in FIGS. 2-4. In FIG. 2, some crystalline structure of spinel can be observed in the as-sprayed powders of the present invention. FIGS. 3 and 4 indicate that the powders of the present invention can form in perfect crystals after being heated for 4 hours.

### COMPARATIVE EXAMPLE 1

According to the traditional solid-state reaction, Li₂CO₃ and Mn(CH₃COO)₂ are ground and mixed in a mole ratio of 1:4. The mixture is then ball milled for 24 hours after adding a proper amount of ethanol. Next, liquid is removed by drying the mixture. The dried mixture is then calcined at 350° C. for 6 hours, 600° C. for 6 hours, and heated at 800° C. for 72 hours. After cooling down to room temperature, the LiMn₂O₄ compound is obtained.

### COMPARATIVE EXAMPLE 2

According to the co-precipitating method, acetates or other water-soluble salts of Li and Mn are dissolved in de-ionized water, wherein the ion ratio of Li to Mn is 1:2. The solution is controlled at pH 6.5-7.5 by adding ammonia. Next, the solution is heated to 70-80° C. and stirred to evaporate water. The dried powders are then calcined at 300° C. for 6 hours, and heated in air at 800° C. for 10 hours to obtain the spinel powders of LiMn₂O₄.

### COMPARATIVE EXAMPLE 3

According to Pechini process, LiNO₃, Mn(NO₃)₂ and citric acid are dissolved in de-ionized water and then mixed together by stirring. The mole ratio of LiNO₃ and Mn(NO₃)₂ is 1:2, and the citric acid is added in an equivalent amount to LiNO₃ and Mn(NO₃)₂. Thee mixture is then heated at 90° C. for 20 minutes and then at 140° C. for 3 hours for esterification. After becoming black and ropy, the solution is heated to 180° C. to remove extra ethylene glycol and an organic polymeric gel is obtained. The organic gel is then calcined in air at 200-300° C. and heated at 600-800° C. to obtain fine powders. Finally, the powders are gradually cooled down to room temperature at a rate of 1° C./min.

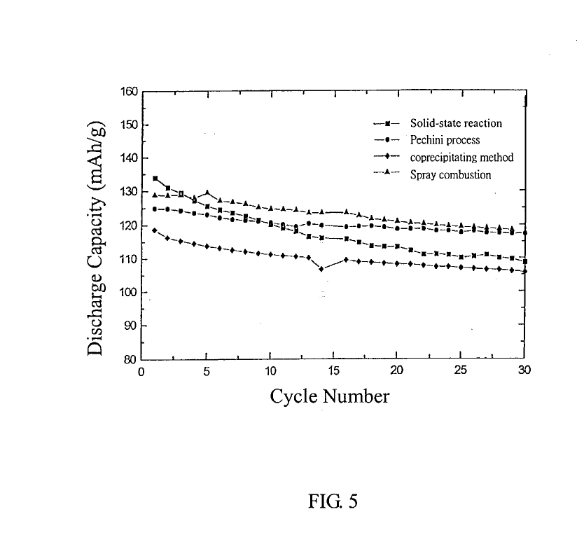

Coin-type batteries formed with the products of Example and Comparative Examples 1-3 are then brought to capacity retention tests. The aforementioned materials are respectively coated on aluminum foils as positive electrodes. Lithium foils serve as the negative electrodes. An electrolyte of LiPF₆ (1M) is prepared with ethylene carbonate and diethylene carbonate in a volume ratio of 1:1. As shown in FIG. 5, the Li-ion secondary battery to which the positive electrode material of the present invention is applied exhibits higher charge/discharge capacity and batter cycling stability then those of other comparative examples.

Although the present invention has been explained in relation to its preferred embodiment, it is to be understood that many other possible modifications and variations can be made without departing from the scope of the invention as hereinafter claimed.

What is claimed is:

1. A method for producing a positive electrode material of the formula (I):
Li₁₊ₓMn_{2-y}M_{y}O₄ (I)
wherein M is Al, Cr, Fe, Co, or Ni, 0≦x≦0.4, 0≦y≦0.2, comprising steps of:
(A) mixing salts of Li, Mn and M with an organic multi-proton acid to form an initial solution, wherein the mole ratio of Li, Mn and M ions in their respective salts is (1+x):(2−y):y;
(B) injecting said initial solution into a spraying chamber of a combustor to generate powders, and adjusting flow rate of said initial solution to maintain the temperature of an output port of said spraying chamber at 150° C.-200° C.; and
(C) heating said powders.

2. The method as claimed in claim 1, wherein said Li salt is selected from the group consisting of nitrate, chloride, hydroxide, carbonate and acetate.

3. The method as claimed in claim 1, wherein said Mn salt is selected from the group consisting of nitrate, chloride, hydroxide, carbonate and acetate.

4. The method as claimed in claim 1, wherein said M salt is selected from the group consisting of nitrate, chloride, hydroxide, carbonate and acetate.

5. The method as claimed in claim 1, wherein said organic acid is selected from the group consisting of acetic acid, propionic acid, butyric acid and citric acid.

6. The method as claimed in claim 1, wherein the mole ratio of said organic acid to Li ion in said Li salt ranges from 1:1 to 5:1.

7. The method as claimed in claim 1, wherein the mole ratio of said organic acid to Li ion in said Li salt ranges from 1:1 to 3:1.

8. The method as claimed in claim 1, wherein said powders are heated at 600° C.-900° C.

9. The method as claimed in claim 1, wherein said powders are heated for 1-8 hours.
